(19) United States
(12) Patent Application Publication
(10) Pub. No.: US 2026/0348926 A1
(43) Pub. Date: Nov. 5, 2026

(54) DATA PROCESSING APPARATUS, DATA PROCESSING METHOD, AND DATA PROCESSING SYSTEM

(71) Applicant: SHIMADZU CORPORATION, Kyoto (JP)

(72) Inventor: Harunori KAWAI, Kyoto (JP)

(73) Assignee: SHIMADZU CORPORATION, Kyoto (JP)

(21) Appl. No.: 19/486,103

(22) PCT Filed: Apr. 25, 2024
(86) PCT No.: PCT/JP2024/016325

§ 371 Date: Nov. 20, 2025

(30) Foreign Application Priority Data
May 30, 2023 (JP) 2023-088511

(51) Int. Cl. G01N 30/86

(52) U.S. Cl. CPC G01N 30/8675; G01N 30/8631

(57) ABSTRACT

A data processing apparatus comprises a data acquisition unit that acquires detection data indicating a signal intensity corresponding to a component in a sample detected by a chromatograph, and a processing unit that processes the detection data acquired by the data acquisition unit. The processing unit generates a chromatogram indicating a time variation of the signal intensity based on the detection data, executes a data process including at least one of a splitting process of splitting one peak to generate a plurality of split peaks and a merging process of merging a plurality of peaks to generate one single peak in the chromatogram, and calculates a Levenshtein distance between the chromatogram and a chromatogram for comparison, based on a result of the data process.

### TECHNICAL FIELD

The present disclosure relates to a data processing apparatus, a data processing method, a data processing program, and a data processing system that process data.

### BACKGROUND ART

As disclosed in Patent Literature 1 (JP 2020-191907 A), a technique called chromatography is known, which uses a chromatograph to separate components contained in a sample to be analyzed.

### CITATION LIST

### Patent Literature

[Patent Literature 1] JP 2020-191907 A

### SUMMARY OF INVENTION

### Technical Problem

According to the chromatograph disclosed in Patent Literature 1, components contained in a sample are separated by a column, and the signal intensity corresponding to the separated components is detected by a detector. A time variation of the signal intensity detected by the chromatograph is output as a separation result called a chromatogram.

In the separation of components contained in a sample using a chromatograph, it is common practice to analyze chromatogram data by separating the same sample under different separation conditions, or by separating a plurality of different samples under the same separation condition. Although multiple chromatograms are acquired to determine the degree of similarity or the correspondence of peak components among the multiple chromatograms, if the analysis conditions for acquiring the multiple chromatograms differ, or if the samples differ, the shapes of the multiple chromatograms will be different from each other, making it difficult to perform data processing on these chromatograms. Furthermore, regarding the degree of similarity among multiple chromatograms, no quantitative expression exists, and the analyst must subjectively determine the degree of similarity. Here, if the arrangement of multiple peaks in a chromatogram is considered as a character string, it is conceivable to verify the degree of similarity of multiple chromatograms using the Levenshtein distance. In that case, it is necessary to match the peaks of the same component between the multiple chromatograms being compared.

However, depending on the separation conditions, components may be detected without being properly separated, which may cause multiple peaks in the chromatogram to overlap. In this case, the peaks cannot be clearly identified, and there is a risk that the peaks cannot be appropriately corresponded between the multiple chromatograms.

The present disclosure has been made to solve such a problem, and its objective is to provide a technology for appropriately acquiring the degree of similarity of a plurality of chromatograms.

### Solution to Problem

A data processing apparatus according to an aspect of the present disclosure comprises a data acquisition unit that acquires detection data indicating a signal intensity corresponding to a component in a sample detected by a chromatograph, and a processing unit that processes the detection data acquired by the data acquisition unit. The processing unit generates a chromatogram indicating a time variation of the signal intensity based on the detection data, executes a data process including at least one of a splitting process of splitting one peak to generate a plurality of split peaks and a merging process of merging a plurality of peaks to generate one single peak in the chromatogram, and calculates a Levenshtein distance between the chromatogram and a chromatogram for comparison, based on a result of the data process.

A data processing method according to another aspect of the present disclosure includes a step of acquiring detection data indicating a signal intensity corresponding to a component in a sample detected by a chromatograph, and a step of processing the detection data acquired by the acquiring step. The step of processing the detection data includes a step of generating a chromatogram indicating a time variation of the signal intensity based on the detection data, a step of executing a data process including at least one of a splitting process of splitting one peak to generate a plurality of split peaks and a merging process of merging a plurality of peaks to generate one single peak in the chromatogram, and a step of calculating a Levenshtein distance between the chromatogram and a chromatogram for comparison, based on a result of the data process.

A data processing program according to another aspect of the present disclosure causes a computer to execute a step of acquiring detection data indicating a signal intensity corresponding to a component in a sample detected by a chromatograph, and a step of processing the detection data acquired by the acquiring step. The step of processing the detection data includes a step of generating a chromatogram indicating a time variation of the signal intensity based on the detection data, a step of executing a data process including at least one of a splitting process of splitting one peak to generate a plurality of split peaks and a merging process of merging a plurality of peaks to generate one single peak in the chromatogram, and a step of calculating a Levenshtein distance between the chromatogram and a chromatogram for comparison, based on a result of the data process.

A data processing system according to another aspect of the present disclosure comprises a chromatograph and a data processing apparatus that processes data. The data processing apparatus comprises a data acquisition unit that acquires detection data indicating a signal intensity corresponding to a component in a sample detected by the chromatograph, and a processing unit that processes the detection data acquired by the data acquisition unit. The processing unit generates a chromatogram indicating a time variation of the signal intensity based on the detection data, executes a data process including at least one of a splitting process of splitting one peak to generate a plurality of split peaks and a merging process of merging a plurality of peaks to generate one single peak in the chromatogram, and calculates a Levenshtein distance between the chromatogram and a chromatogram for comparison, based on a result of the data process.

### Advantageous Effects of Invention

According to the present disclosure, in a chromatogram generated based on detection data from a chromatograph, by splitting one peak or merging a plurality of peaks, the peaks in the generated chromatogram can be matched to the peaks in a chromatogram for comparison, and therefore the degree of similarity of a plurality of chromatograms can be appropriately acquired using the Levenshtein distance.

### BRIEF DESCRIPTION OF DRAWINGS

FIG. 1 is a diagram showing a configuration of a data processing system and a data processing apparatus according to an embodiment.

FIG. 2 is a diagram showing a spectrum vector generated by the data processing apparatus according to the embodiment.

FIG. 3 is a diagram showing three-dimensional vector data constituted by a spectrum vector and a chromatogram generated by the data processing apparatus according to the embodiment.

FIG. 4 is a diagram for explaining peak tracking using a plurality of chromatograms.

FIG. 5 is a diagram showing an example of the degree of similarity between a plurality of chromatograms.

FIG. 6 is a diagram for explaining the Levenshtein distance.

FIG. 7 is a diagram for explaining a substitution process executed by the data processing apparatus according to the embodiment.

FIG. 8 is a diagram for explaining an insertion process executed by the data processing apparatus according to the embodiment.

FIG. 9 is a diagram for explaining a deletion process executed by the data processing apparatus according to the embodiment.

FIG. 10 is a diagram for explaining a moving process executed by the data processing apparatus according to the embodiment.

FIG. 11 is a diagram for explaining a splitting process executed by the data processing apparatus according to the embodiment.

FIG. 12 is a diagram for explaining a merging process executed by the data processing apparatus according to the embodiment.

FIG. 13 is a diagram showing an example in which the data processing apparatus calculates the Levenshtein distance between a plurality of chromatograms by a data process according to the embodiment.

FIG. 14 is a flowchart of a data process executed by the data processing apparatus according to the embodiment.

### DESCRIPTION OF EMBODIMENTS

The present embodiment will be described in detail while referencing the drawings. Note that for identical or corresponding parts in the drawings, the same reference signs are assigned, and their description will not be repeated in principle.

### Configuration of Data Processing System and Data Processing Apparatus

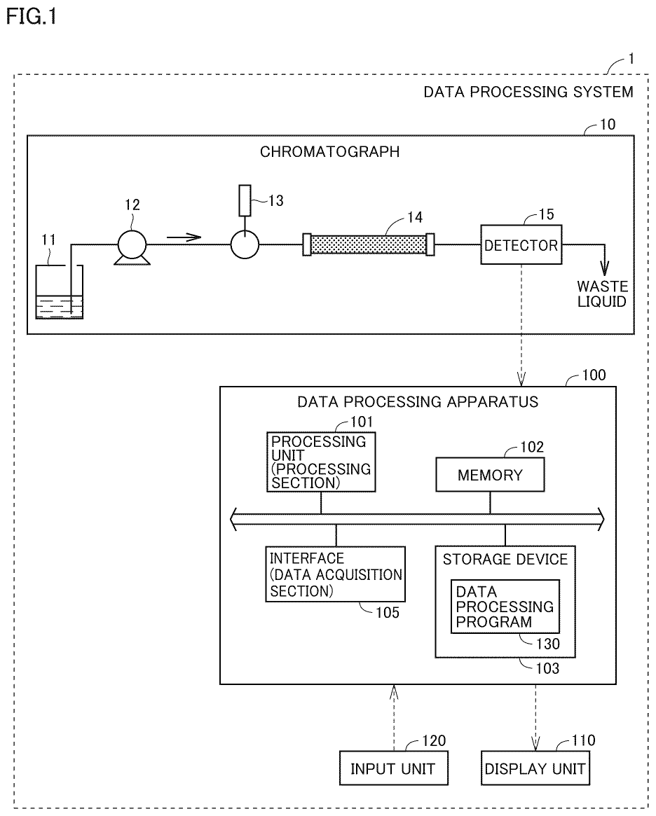

The configuration of a data processing system 1 and a data processing apparatus 100 according to an embodiment will be described while referencing FIG. 1. FIG. 1 is a diagram showing the configuration of the data processing system 1 and the data processing apparatus 100 according to the embodiment. As shown in FIG. 1, the data processing system 1 comprises a chromatograph 10 and the data processing apparatus 100

The chromatograph 10 comprises a container 11, a liquid sending pump 12, an injector 13, a column 14, and a detector 15. The container 11 accommodates a mobile phase. The liquid sending pump 12 suctions the mobile phase from the container 11 and supplies it at a constant flow rate. The injector 13 injects a sample to be analyzed into the mobile phase supplied by the liquid sending pump 12. The column 14 accommodates a stationary phase and separates various components contained in the sample injected by the injector 13. The detector 15 detects components eluted from the column 14. As the detector 15, for example, a photodiode array (PDA) detector, a fluorescence detector, a differential refractive index detector, a conductivity detector, or a mass spectrometer is used. Detection data indicating a signal intensity corresponding to the components in the sample detected by the detector 15 is output to the data processing apparatus 100.

Note that although the chromatograph 10 according to the embodiment is a liquid chromatograph (LC) that uses a liquid as a mobile phase, the chromatograph 10 may be another type of chromatograph such as a gas chromatograph that uses a gas as a mobile phase.

In the chromatograph 10, the sample to be analyzed is injected into the mobile phase by the injector 13. The injected sample rides on the flow of the mobile phase supplied by the liquid sending pump 12 to reach the column 14 and passes through the inside of the column 14. For the various components contained in the sample, the time to pass through the inside of the column 14 differs depending on the affinity with the stationary phase or the mobile phase. For example, among the components contained in the sample, components that are easily adsorbed to the stationary phase have a longer time to pass through the inside of the column 14 (also referred to as “retention time”) than components that are not easily adsorbed to the stationary phase. Thereby, the various components contained in the sample are separated in the time direction by the column 14. An eluate containing the components separated in the column 14 is introduced from the column 14 to the detector 15. The detector 15 outputs detection data indicating a signal intensity according to the concentration (amount) of the components introduced by the column 14. The detection data is processed by the data processing apparatus 100, whereby a chromatogram is generated. Note that the solution that has passed through the detector 15 is discharged as waste liquid.

The data processing apparatus 100 may be a general-purpose computer or may be a dedicated computer for the data processing system 1 for processing detection data from the chromatograph 10. The data processing apparatus 100 comprises a processing unit 101, a memory 102, a storage device 103, and an interface 104.

The processing unit 101 is an example of a “processing unit”. The processing unit 101 is a processing entity (computer) that executes various processes by executing various programs. The processing unit 101 is configured with, for example, a processor such as a CPU (central processing unit) or an MPU (Micro-processing unit). Note that although a processor, which is an example of the processing unit 101, has a function of executing various processes by executing a program, a part or all of these functions may be implemented using a dedicated hardware circuit such as an ASIC (Application Specific Integrated Circuit) or an FPGA (Field-Programmable Gate Array). A “processor” is not limited to a processor in a narrow sense that executes processing by a stored-program method, such as a CPU or an MPU, but may include a hard-wired circuit such as an ASIC or an FPGA. For this reason, a “processor”, which is an example of the processing unit 101, can also be read as a processing circuitry, in which processing is predefined by computer-readable code and/or a hard-wired circuit. Note that the processing unit 101 may be configured with a single chip or with a plurality of chips. Furthermore, the processor and related processing circuitry may be configured with a plurality of computers interconnected by wire or wirelessly via a local area network or a wireless network. The processor and related processing circuitry may be configured with a cloud computer that performs calculations remotely based on input data and outputs the calculation results to other devices at a distant location.

The memory 102 includes a volatile storage area (for example, a working area) that temporarily stores program codes, work memory, and the like when the processing unit 101 executes various programs. Examples of the storage unit include volatile memories such as DRAM (dynamic random access memory) and SRAM (static random access memory), or non-volatile memories such as ROM (Read Only Memory) and flash memory.

The storage device 103 stores various programs executed by the processing unit 101, various data, and the like. The storage device 103 may be one or a plurality of non-transitory computer readable media, or may be one or a plurality of computer readable storage media. Examples of the storage device 103 include an HDD (Hard Disk Drive) and an SSD (Solid State Drive). The storage device 103 according to the embodiment stores a data processing program 130 for the processing unit 101 to execute a data process for processing the detection data acquired from the chromatograph 10.

The interface 104 is an example of a “data acquisition unit”. The interface 104 transmits and receives data to and from an external apparatus or external equipment via wired communication or wireless communication. For example, the interface 104 communicates with the chromatograph 10 to acquire detection data output from the chromatograph 10. Further, the interface 104 may be a communication device that communicates with a cloud server (not shown) to transmit the detection data acquired from the chromatograph 10 to the cloud server, or for the processing unit 101 to transmit a result of the data process (for example, the calculated Levenshtein distance) to the cloud server. Furthermore, the interface 104 may transmit and receive data to and from a display unit 110 or an input unit 120, which are user interfaces, via wired communication or wireless communication. The data processing apparatus 100 is not limited to one interface 104 and may comprise a plurality of interfaces 104 according to the number of communication targets.

The display unit 110 is a display configured with, for example, a liquid crystal panel, and displays a result of the data process by the data processing apparatus 100 (for example, the calculated Levenshtein distance). The input unit 120 is a pointing device such as a keyboard or a mouse, and accepts commands from a user. When a touch panel is used as a user interface, the display unit 110 and the input unit 120 may be integrally formed. Note that the display unit 110 and the input unit 120 may be configurations comprised in the data processing apparatus 100.

In the data processing system 1 configured as described above, the data processing apparatus 100 acquires, via the interface 104, detection data indicating the signal intensity corresponding to the components in the sample detected by the chromatograph 10 in a time series. The data processing apparatus generates a chromatogram indicating a time variation of the signal intensity based on the acquired detection data. Thereby, the data processing apparatus 100 can acquire a chromatogram related to the components contained in the sample to be analyzed.

### Example of Chromatogram

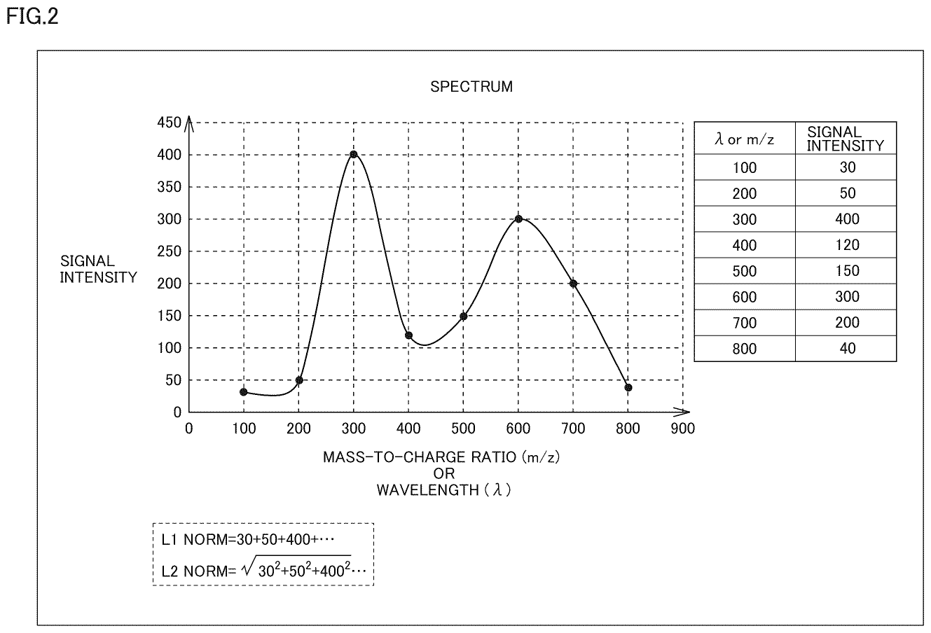

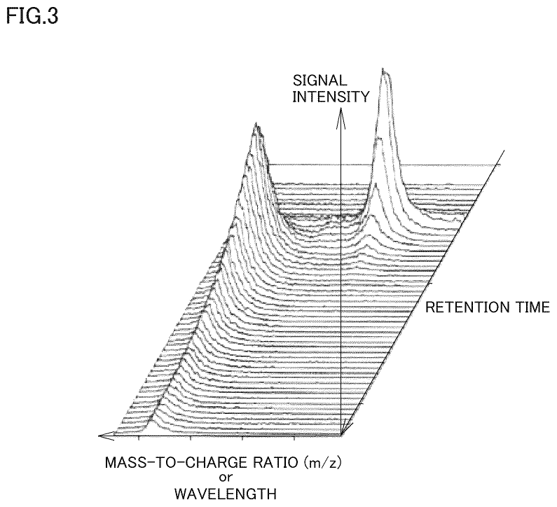

A chromatograph processed by the data processing apparatus 100 according to the embodiment will be described while referencing FIG. 2 and FIG. 3. FIG. 2 is a diagram showing a spectrum vector generated by the data processing apparatus 100 according to the embodiment.

The data processing apparatus 100 can generate a spectrum vector based on the detection data acquired from the chromatograph 10. For example, when the chromatograph 10 is configured to detect the ion intensity of various components contained in a sample as a signal intensity for each mass-to-charge ratio, the data processing apparatus 100 can generate a mass spectrum vector indicating the signal intensity with respect to the mass-to-charge ratio at a specific time, based on the detection data acquired from the chromatograph 10. Alternatively, when the chromatograph 10 is configured to detect the absorbance of various components contained in a sample as a signal intensity for each wavelength, the data processing apparatus 100 can generate a wavelength spectrum vector indicating the signal intensity with respect to the wavelength at a specific time, based on the detection data acquired from the chromatograph 10.

In FIG. 2, a spectrum vector is shown where the horizontal axis represents mass-to-charge ratio (m/z) or wavelength (λ), and the vertical axis represents signal intensity (ion intensity or absorbance). The data processing apparatus 100 can calculate an L1 norm, indicated by the sum of the absolute values of each vector value (signal intensity), or an L2 norm, indicated by the square root of the sum of the squares of each vector value (signal intensity), from such a spectrum vector.

For example, in the example shown in FIG. 2, the L1 norm is calculated by adding the signal intensity “30” at the wavelength “100 nm”, the signal intensity “50” at the wavelength “200 nm”, the signal intensity “400” at the wavelength “300 nm”, and so on. Also, the L2 norm is calculated by the square root of a value obtained by adding the square of the signal intensity “30” at the wavelength “100 nm”, the square of the signal intensity “50” at the wavelength “200 nm”, the square of the signal intensity “400” at the wavelength “300 nm”, and so on.

Thus, when the chromatograph 10 detects the ion intensity of a component in a sample as a signal intensity for each mass-to-charge ratio, the chromatogram indicates a time variation of each ion intensity detected for each mass-to-charge ratio by the chromatograph 10. Also, when the chromatograph 10 detects the absorbance of a component in a sample as a signal intensity for each wavelength, the chromatogram indicates a time variation of each absorbance detected for each wavelength by the chromatograph 10.

FIG. 3 is a diagram showing three-dimensional vector data constituted by a spectrum vector and a chromatogram generated by the data processing apparatus 100 according to the embodiment. Although FIG. 2 showed a spectrum vector at a specific time, the data processing apparatus 100 can generate three-dimensional vector data as shown in FIG. 3 by arranging such spectrum vectors in a time series for each retention time. The data processing apparatus 100 can generate a chromatogram by taking retention time on the horizontal axis and signal intensity (ion intensity or absorbance) on the vertical axis. That is, a chromatogram is data indicating a time variation of signal intensity. Hereinafter, each signal intensity possessed by each peak in a chromatogram is also simply referred to as a “vector value”.

### Example of Peak Tracking

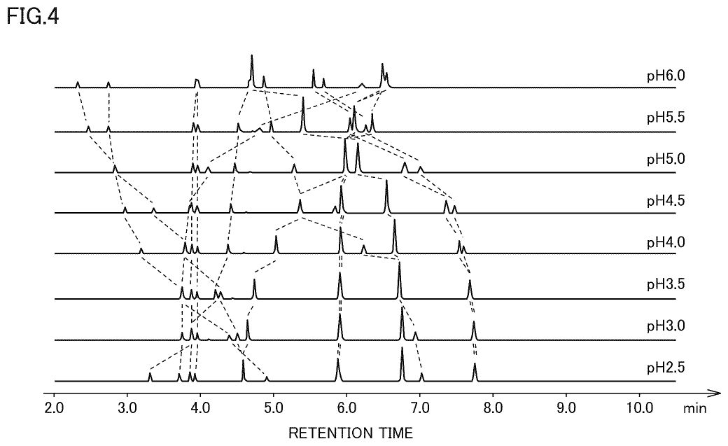

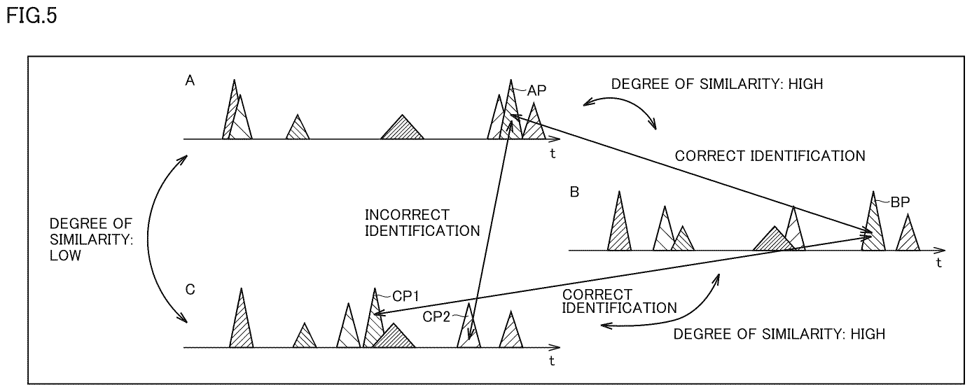

Peak tracking will be described while referencing FIG. 4 and FIG. 5. FIG. 4 is a diagram for explaining peak tracking using a plurality of chromatograms. FIG. 4 shows an example of peak tracking using a plurality of chromatograms obtained when the same sample is separated under different separation conditions. Specifically, a case is assumed where the hydrogen ion concentration index in a solution that is a mobile phase is set to a plurality of indices between pH 2.5 and pH 6.0, and a chromatogram is generated at each index.

An analyst can investigate the optimal separation conditions for separating the components contained in a sample by comparing among the plurality of chromatograms obtained for each separation condition, such as the hydrogen ion concentration index. At that time, the analyst can efficiently investigate the optimal separation conditions by tracking how the retention time of each peak in each chromatogram changes according to the separation conditions. By performing such peak tracking, the analyst can identify the peak of the same component in each chromatogram.

Here, in performing peak tracking, it is required to extract two chromatograms in which the position (retention time) and vector value of each peak are similar from among the plurality of chromatograms, and to perform peak tracking between the two extracted chromatograms. In this way, if peak tracking is performed between a plurality of similar chromatograms, the optimal separation conditions can be efficiently investigated. For example, in the example of FIG. 4, among the plurality of chromatograms, for the chromatogram in the case of pH 6.0, the degree of similarity of the chromatogram in the case of pH 5.5 is the largest. For this reason, peak tracking is performed between the chromatogram in the case of pH 6.0 and the chromatogram in the case of pH 5.5.

FIG. 5 is a diagram showing an example of the degree of similarity between a plurality of chromatograms. As shown in FIG. 5, a case is assumed where the degree of similarity between chromatogram A and chromatogram B is higher than the degree of similarity between chromatogram A and chromatogram C, and the degree of similarity between chromatogram B and chromatogram C is higher than the degree of similarity between chromatogram A and chromatogram C.

When using chromatogram A and chromatogram B, the analyst can correctly identify both by assuming that for the peak AP detected sixth in chromatogram A, the peak BP detected sixth in chromatogram B corresponds. Also, when using chromatogram B and chromatogram C, the analyst can correctly identify both by assuming that for the peak BP detected sixth in chromatogram B, the peak CP1 detected fourth in chromatogram C corresponds. On the other hand, when using chromatogram A and chromatogram C, the analyst may assume that for the peak AP detected sixth in chromatogram A, the peak CP2 detected sixth in chromatogram C corresponds, and there is a risk of incorrectly identifying them.

Also, although FIG. 5 illustrates that the degree of similarity between chromatogram A and chromatogram B is higher than the degree of similarity between chromatogram A and chromatogram C, such a judgment depends on the analyst's subjectivity, so when comparing more complex multiple chromatograms, it is difficult for the analyst to accurately evaluate the degree of similarity.

### Example of Levenshtein Distance

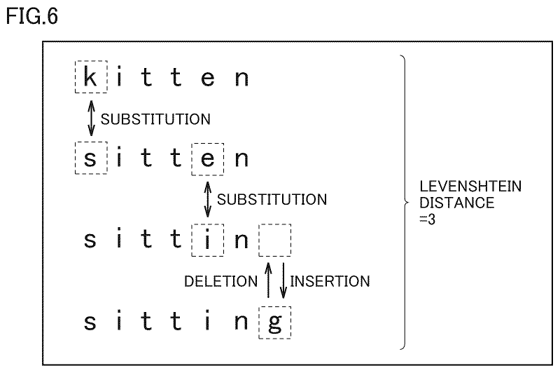

As mentioned above, the Levenshtein distance can be used as a method for finding chromatograms with a high degree of similarity from among a plurality of chromatograms. The Levenshtein distance is a type of distance that indicates how different two character strings are. An example of the Levenshtein distance will be described while referencing FIG. 6. FIG. 6 is a diagram for explaining the Levenshtein distance.

As shown in FIG. 6, for example, when calculating the minimum Levenshtein distance between “kitten” and “sitting”, one may calculate the number of steps in transforming “kitten” to “sitting”, or the number of steps in transforming “sitting” to “kitten”.

For example, when “kitten” is transformed to “sitting” in the shortest way, as a first step, the first “k” in “kitten” is substituted with “s”, thereby transforming “kitten” to “sitten”. As a second step, the fifth “e” in “sitten” is substituted with “i”, thereby transforming “sitten” to “sittin”. As a third step, “g” is inserted at the seventh position after “sittin”, thereby transforming “sittin” to “sitting”.

Also, when “sitting” is transformed to “kitten” in the shortest way, as a first step, the seventh “g” in “sitting” is deleted, thereby transforming “sitting” to “sittin”. As a second step, the fifth “i” in “sittin” is substituted with “e”, thereby transforming “sittin” to “sitten”. As a third step, the first “s” in “sitten” is substituted with “k”, thereby transforming “sitten” to “kitten”.

Note that the steps that can be taken when transforming from “kitten” to “sitting”, or the steps that can be taken when transforming from “sitting” to “kitten”, are not limited to the steps shown in FIG. 6, and other steps are conceivable. The number of steps when transforming from “kitten” to “sitting”, or the number of steps that can be taken when transforming from “sitting” to “kitten”, differs depending on which process among substitution, deletion, insertion, and the like is executed and in what order.

As in the example shown in FIG. 6, in both the case where “kitten” is transformed to “sitting” in the shortest way, and the case where “sitting” is transformed to “kitten” in the shortest way, the minimum Levenshtein distance is “3”, consisting of the first to third steps.

The data processing apparatus 100 according to the embodiment regards one peak contained in a chromatogram as one character, and regards the array of all peaks contained in the chromatogram as a character string, and applies the Levenshtein distance to the chromatogram. In the data processing apparatus 100, the processing unit 101 is configured to calculate the minimum Levenshtein distance for all combinations in a plurality of chromatograms by executing a data process according to the data processing program 130.

### Example of Data Processing

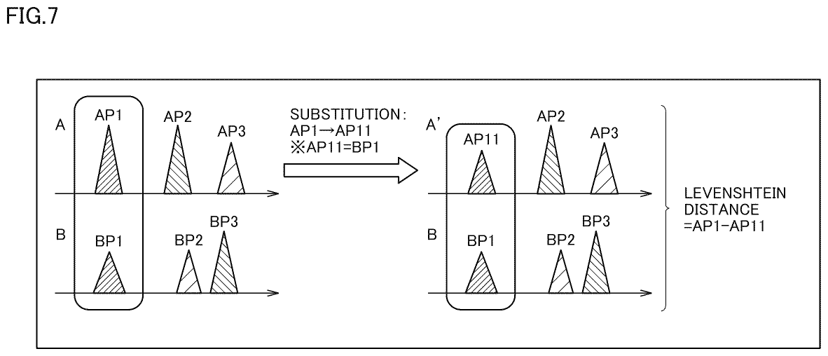

An example of a data process executed by the data processing apparatus 100 will be described while referencing FIG. 7 to FIG. 13. In FIG. 7 to FIG. 13, it is assumed that the Levenshtein distance between chromatogram A and chromatogram B is calculated. For example, it is assumed that the data processing apparatus 100 executes a data process on at least one peak in chromatogram A, thereby bringing chromatogram A closer to chromatogram B, and calculates the number of steps required to make chromatogram A and chromatogram B coincide (that is, the Levenshtein distance). As will be described in detail later, in the data processing apparatus 100 according to the embodiment, the data process includes a plurality of processes such as a substitution process, an insertion process, a deletion process, a moving process, a splitting process, and a merging process.

FIG. 7 is a diagram for explaining a substitution process executed by the data processing apparatus 100 according to the embodiment. As shown in FIG. 7, the data processing apparatus 100 executes a substitution process of substituting the vector value of at least one peak in a specific chromatogram with another vector value. Specifically, the data processing apparatus 100 executes the substitution process to substitute the vector value of at least one peak (each signal intensity detected for each mass-to-charge ratio or wavelength) in a specific chromatogram with the same value as the vector value of a comparison target peak in a chromatogram for comparison.

For example, as shown in FIG. 7, it is assumed that when the data processing apparatus 100 brings chromatogram A closer to chromatogram B, it makes the peak AP1 detected first in chromatogram A coincide with the peak BP1 detected first in chromatogram B. In this case, the data processing apparatus 100 executes the substitution process, and by adding or subtracting a predetermined value to or from the vector value of the peak AP1 in chromatogram A so as to make it coincide with the vector value of the peak BP1 in chromatogram B, it substitutes the vector value of the peak AP1 with the vector value of a peak AP11. The vector value of the peak AP11 in the chromatogram A′ after the substitution process coincides with the vector value of the comparison target peak BP1 in the chromatogram for comparison B.

The data processing apparatus 100 calculates, as the Levenshtein distance, the difference between the vector value of the peak AP1 and the vector value of the peak BP1 (AP11) that occurred in the substitution process, that is, the norm of the vector value added to the vector value of the peak AP1. For example, if the vector value of the peak AP1 is “100 nm: 50, 500 nm: 90” and the vector value of the peak BP1 (AP11) is “100 nm: 20, 500 nm: 50”, then by the substitution process, the norm of a vector value of “100 nm: 30, 500 nm: 40” is added to the vector value of peak AP1. In this case, the data processing apparatus 100 calculates, as the norm to be added as the Levenshtein distance, for example, “70” in the case of the L1 norm, and “50” in the case of the L2 norm. Also, if the vector value of the peak AP1 is “100 nm: 20, 500 nm: 50” and the vector value of the peak BP1 (AP11) is “100 nm: 50, 500 nm: 90”, then by the substitution process, the norm of a vector value of “100 nm: 30, 500 nm: 40” is added to the vector value of peak AP1. In this case, the data processing apparatus 100 calculates, as the norm to be added as the Levenshtein distance, for example, “70” in the case of the L1 norm, and “50” in the case of the L2 norm. Note that the data processing apparatus 100, when calculating the Levenshtein distance, may add a fixed value instead of using the absolute value norm of the difference of the vector values in the plurality of peaks. The fact that the vector values in a plurality of peaks are similar can be considered that the corresponding components are similar, and in the case of considering the number of differing components as the distance, it is better to use a fixed value.

In this way, the data processing apparatus 100, by executing the substitution process, can make a peak in a specific chromatogram coincide with a comparison target peak in a chromatogram for comparison, and can calculate the effort that occurred at that time as the Levenshtein distance. After that, the data processing apparatus 100 compares the next processing target AP2 in chromatogram A and the next comparison target BP2 in the chromatogram for comparison B and calculates the Levenshtein distance.

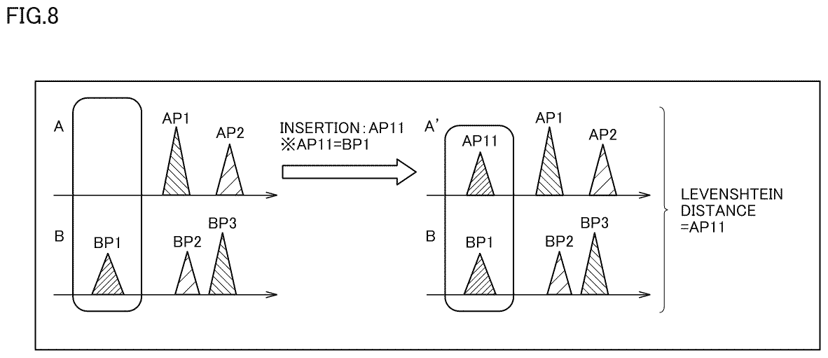

FIG. 8 is a diagram for explaining an insertion process executed by the data processing apparatus 100 according to the embodiment. As shown in FIG. 8, the data processing apparatus 100 executes an insertion process of inserting at least one peak in a specific chromatogram. Specifically, the data processing apparatus 100 executes the insertion process to newly add a peak having the same vector value (each signal intensity detected for each mass-to-charge ratio or wavelength) as a comparison target peak in a chromatogram for comparison, to the specific chromatogram.

For example, as shown in FIG. 8, it is assumed that when the data processing apparatus 100 brings chromatogram A closer to chromatogram B, it inserts a peak AP11 in chromatogram A. In this case, the data processing apparatus 100 executes the insertion process to insert a peak AP11 having the same vector value as the peak BP1 detected first in chromatogram B, at the first detection timing of chromatogram A. The vector value of the peak AP11 in the chromatogram A′ after the insertion process coincides with the vector value of the comparison target peak BP1 in the chromatogram for comparison B. The data processing apparatus 100 calculates, as the Levenshtein distance, the norm of the vector value of the peak AP11 that occurred in the insertion process, that is, the vector value of the peak AP11 added at the detection timing where no peak originally existed. For example, if the vector value of the peak BP1 is “100 nm: 30, 500 nm: 40”, the data processing apparatus 100 calculates, as the norm of the vector value of the peak AP11 to be inserted as the Levenshtein distance, for example, “70” in the case of the L1 norm, and “50” in the case of the L2 norm. Note that the data processing apparatus 100 may make the norm to be inserted a fixed value, regardless of the mass-to-charge ratio or wavelength of the peak to be inserted.

In this way, the data processing apparatus 100, by executing the insertion process, can insert a peak having the same vector value as a comparison target peak in a chromatogram for comparison into a specific chromatogram, and can calculate the effort that occurred at that time as the Levenshtein distance. After that, the data processing apparatus 100 compares the next processing target AP1 in chromatogram A and the next comparison target BP2 in the chromatogram for comparison B and calculates the Levenshtein distance.

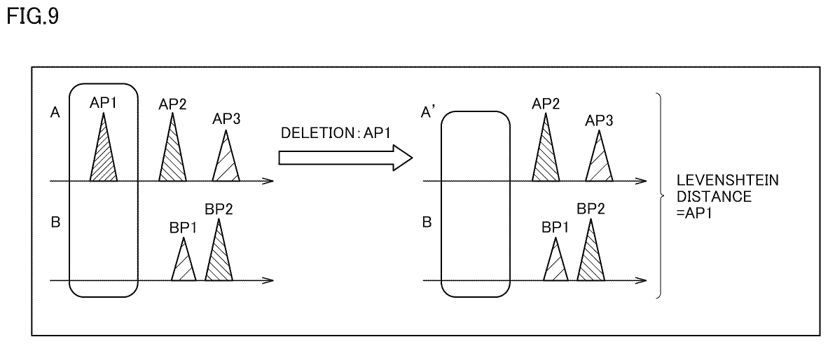

FIG. 9 is a diagram for explaining a deletion process executed by the data processing apparatus 100 according to the embodiment. As shown in FIG. 9, the data processing apparatus 100 executes a deletion process of deleting at least one peak in a specific chromatogram. Specifically, the data processing apparatus 100 executes the deletion process to delete a peak that does not exist in a chromatogram for comparison from the specific chromatogram.

For example, as shown in FIG. 9, it is assumed that when the data processing apparatus 100 brings chromatogram A closer to chromatogram B, it deletes the peak AP1 in chromatogram A. In this case, the data processing apparatus 100 executes the deletion process to delete the first peak AP1 in chromatogram A, which does not exist in chromatogram B. In the chromatogram A′ after the deletion process, the peak AP1 does not exist, so as to match chromatogram B.

The data processing apparatus 100 calculates, as the Levenshtein distance, the norm of the vector value of the peak AP1 that occurred in the deletion process, that is, the vector value of the peak AP1 subtracted from chromatogram A. For example, if the vector value of the peak AP1 is “100 nm: 30, 500 nm: 40”, the data processing apparatus 100 calculates, as the norm of the vector value of the peak AP1 to be deleted as the Levenshtein distance, for example, “70” in the case of the L1 norm, and “50” in the case of the L2 norm.

In this way, the data processing apparatus 100, by executing the deletion process, can delete a peak that does not exist in a chromatogram for comparison from a specific chromatogram, and can calculate the effort that occurred at that time as the Levenshtein distance. After that, the data processing apparatus 100 compares the next processing target AP2 in chromatogram A and the next comparison target BP1 in the chromatogram for comparison B and calculates the Levenshtein distance.

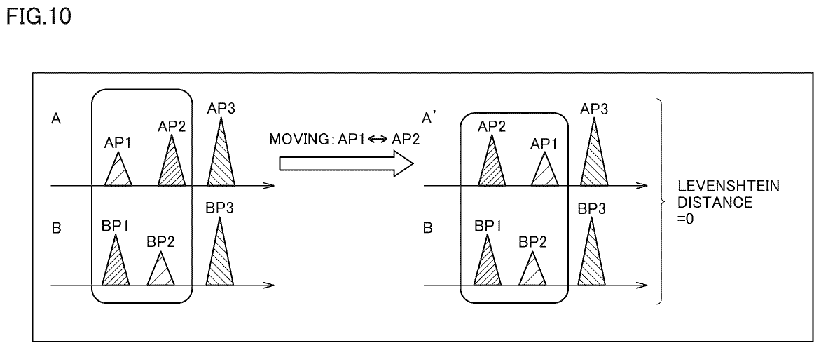

FIG. 10 is a diagram for explaining a moving process executed by the data processing apparatus 100 according to the embodiment. As shown in FIG. 10, the data processing apparatus 100 executes a moving process of moving at least one peak in a specific chromatogram to another time. Specifically, the data processing apparatus 100 executes the moving process to swap a specific peak existing in a specific chromatogram with another peak, thereby changing the order in which the peaks appear.

For example, as shown in FIG. 10, it is assumed that when the data processing apparatus 100 brings chromatogram A closer to chromatogram B, it moves the peak AP1 in chromatogram A to another time. The vector value of the second peak AP2 in chromatogram A is the same as the vector value of the first peak BP1 in chromatogram B. In this case, the data processing apparatus 100 executes the moving process to swap the first peak AP1 and the second peak AP2 in chromatogram A. In the chromatogram A′ after the moving process, the peak AP2 exists first, and the peak AP1 exists second, so as to match chromatogram B.

In the moving process, since the overall vector value in chromatogram A has not changed, the data processing apparatus 100 does not calculate the Levenshtein distance even if it executes the moving process. Note that the data processing apparatus 100 may calculate the effort generated by executing the moving process as the Levenshtein distance. For example, the data processing apparatus 100 may calculate a predetermined Levenshtein distance when it executes the moving process.

In this way, the data processing apparatus 100, by executing the moving process, can move a peak in a specific chromatogram to another detection timing, thereby making the peak after moving match a comparison target peak in a chromatogram for comparison. After that, the data processing apparatus 100 compares the next processing target AP1 in chromatogram A and the next comparison target BP2 in the chromatogram for comparison B and calculates the Levenshtein distance.

As described above, the data processing apparatus 100 is configured to execute multiple types of data processes, such as a substitution process, an insertion process, a deletion process, and a moving process, when calculating the degree of similarity between a plurality of chromatograms. Here, in a chromatogram, components may be detected without being properly separated by the chromatograph, causing a plurality of peaks to overlap. For this reason, unlike the calculation of the Levenshtein distance for a character string shown in FIG. 6, in a chromatogram, a peak cannot be clearly identified, and there is a risk that peaks cannot be appropriately corresponded between a plurality of chromatograms.

Therefore, the data processing apparatus 100 according to the embodiment is configured to execute at least one of a splitting process of splitting one peak in a chromatogram to generate a plurality of peaks (hereinafter, also referred to as “split peaks”), and a merging process (merge process) of merging a plurality of peaks in a chromatogram to generate one peak (hereinafter, also referred to as a “single peak”), when calculating the Levenshtein distance between a plurality of chromatograms.

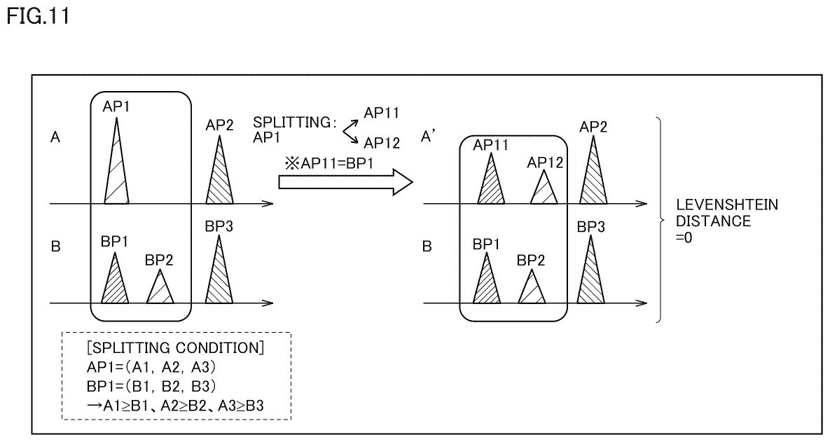

FIG. 11 is a diagram for explaining a splitting process executed by the data processing apparatus 100 according to the embodiment. As shown in FIG. 11, the data processing apparatus 100 executes a splitting process of splitting one peak in a specific chromatogram to generate a plurality of split peaks. Specifically, the data processing apparatus 100 executes the splitting process to split one peak in a specific chromatogram and generate a split peak at each of a plurality of different detection timings.

For example, as shown in FIG. 11, it is assumed that when the data processing apparatus 100 brings chromatogram A closer to chromatogram B, it splits the peak AP1 in chromatogram A. It is assumed that the peak AP1 in chromatogram A includes the peak BP1 in chromatogram B. In this case, the data processing apparatus 100 executes the splitting process to split the peak AP1 detected first in chromatogram A into a first peak AP11 and a second peak AP12. In the chromatogram A′ after the splitting process, a peak AP11 exists at the first detection timing, and a peak AP12 exists at the second detection timing, so as to match chromatogram B. The vector value of the peak AP11 is the same as the vector value of the peak BP1, and the vector value of the peak AP12 becomes a vector value obtained by subtracting the peak AP11 from the peak AP1.

In the splitting process, since the overall vector value in chromatogram A has not changed, the data processing apparatus 100 does not calculate the Levenshtein distance even if it executes the splitting process. Note that the data processing apparatus 100 may calculate the effort generated by executing the splitting process as the Levenshtein distance. For example, the data processing apparatus 100 may calculate a predetermined Levenshtein distance when it executes the splitting process.

In this way, the data processing apparatus 100, by executing the splitting process, can split a peak in a specific chromatogram into a plurality of split peaks, thereby making the split peaks after splitting match a comparison target peak in a chromatogram for comparison. After that, the data processing apparatus 100 compares the next processing target AP12 in chromatogram A and the next comparison target BP2 in the chromatogram for comparison B and calculates the Levenshtein distance.

Here, as explained using FIG. 2 and FIG. 3, the vector value of a peak in a chromatogram corresponds to each signal intensity detected for each mass-to-charge ratio or wavelength. For example, in the example of FIG. 11, the peak AP1 is composed of a vector value A1 corresponding to a first mass-to-charge ratio (or a first wavelength), a vector value A2 corresponding to a second mass-to-charge ratio (or a second wavelength), and a vector value A3 corresponding to a third mass-to-charge ratio (or a third wavelength). Also, the peak BP1 is composed of a vector value B1 corresponding to a first mass-to-charge ratio (or a first wavelength), a vector value B2 corresponding to a second mass-to-charge ratio (or a second wavelength), and a vector value B3 corresponding to a third mass-to-charge ratio (or a third wavelength).

The data processing apparatus 100 executes the splitting process when the vector value of one peak to be split in chromatogram A (each signal intensity detected for each mass-to-charge ratio or wavelength) is larger than the vector value of a comparison target peak in the chromatogram for comparison B (each signal intensity detected for each mass-to-charge ratio or wavelength).

For example, the data processing apparatus 100 determines that a splitting condition is satisfied and executes the splitting process when each of the vector value A1, the vector value A2, and the vector value A3 in the peak to be split AP1 in chromatogram A is larger than the vector value B1, the vector value B2, and the vector value B3 in the comparison target peak BP1 in the chromatogram for comparison B. On the other hand, if even one of the vector value A1, the vector value A2, and the vector value A3 in the peak to be split AP1 in chromatogram A is smaller than the vector value in the comparison target peak BP1 in the chromatogram for comparison B, the data processing apparatus 100 cannot generate the same peak as the comparison target peak BP1 even if it splits the peak to be split AP1, and therefore prohibits the execution of the splitting process.

In this way, the data processing apparatus 100 executes the splitting process only when it can generate the same peak as the comparison target peak if it splits the peak to be split, and therefore can avoid executing a useless splitting process.

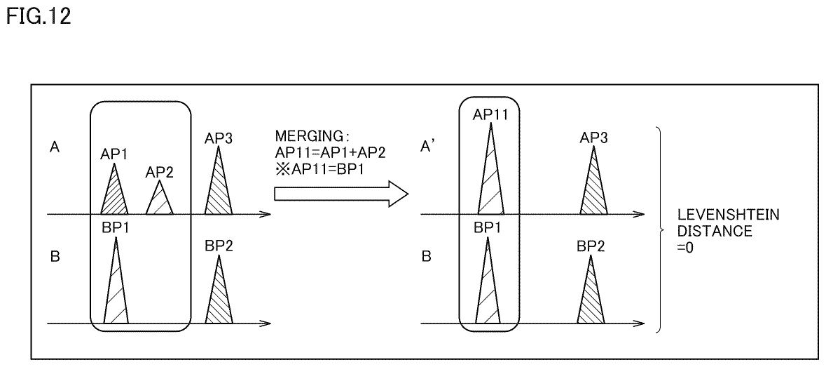

FIG. 12 is a diagram for explaining a merging process executed by the data processing apparatus 100 according to the embodiment. As shown in FIG. 12, the data processing apparatus 100 executes a merging process of merging a plurality of peaks in a specific chromatogram to generate one single peak. Specifically, the data processing apparatus 100 executes the merging process to merge a plurality of peaks detected at each of a plurality of different detection timings of a specific chromatogram and generate a single peak at one detection timing.

For example, as shown in FIG. 12, it is assumed that when the data processing apparatus 100 brings chromatogram A closer to chromatogram B, it merges the first peak AP1 and the second AP2 in chromatogram A. It is assumed that the peak BP1 in chromatogram B is what results from the peak AP1 and the peak AP2 in chromatogram A overlapping. In this case, the data processing apparatus 100 executes the merging process to merge the peak AP1 detected first and the peak AP2 detected second in chromatogram A. In the chromatogram A′ after the merging process, a peak AP11 exists so as to match the peak BP1 in chromatogram B. The vector value of the peak AP11 is the same as the vector value of the peak BP1.

In the merging process, since the overall vector value in chromatogram A has not changed, the data processing apparatus 100 does not calculate the Levenshtein distance even if it executes the merging process. Note that the data processing apparatus 100 may calculate the effort generated by executing the merging process as the Levenshtein distance. For example, the data processing apparatus 100 may calculate a predetermined Levenshtein distance when it executes the merging process.

In this way, the data processing apparatus 100, by executing the merging process, can merge a plurality of peaks in a specific chromatogram, thereby making the single peak after merging match a comparison target peak in a chromatogram for comparison. After that, the data processing apparatus 100 compares the next processing target AP3 in chromatogram A and the next comparison target BP2 in the chromatogram for comparison B and calculates the Levenshtein distance.

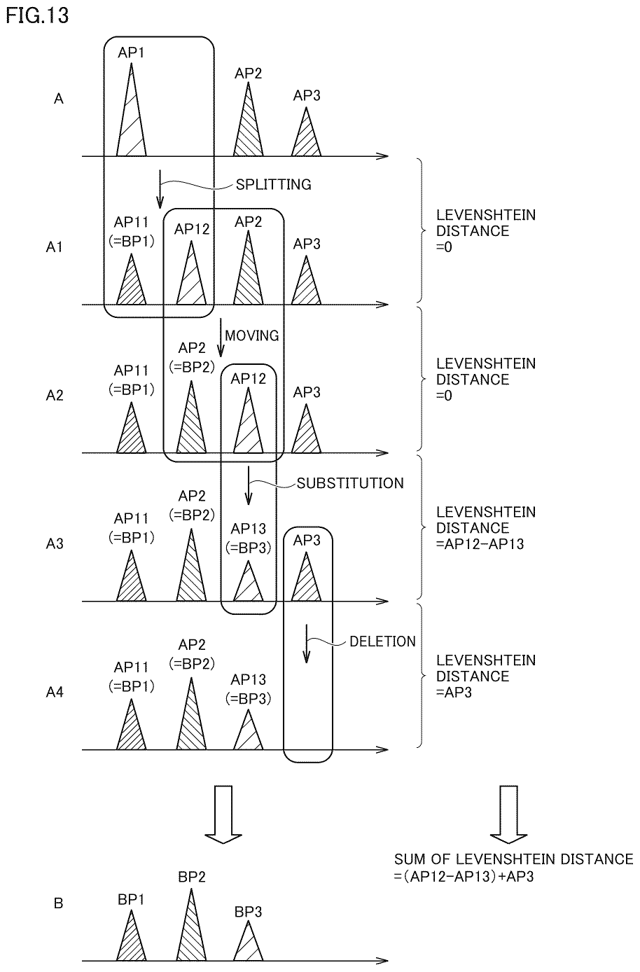

FIG. 13 is a diagram showing an example in which the data processing apparatus 100 calculates the Levenshtein distance between a plurality of chromatograms by a data process according to the embodiment. In the example shown in FIG. 13, it is assumed that the data processing apparatus 100 executes a data process on chromatogram A, thereby bringing it closer to chromatogram B, and calculates the Levenshtein distance when making chromatogram A and chromatogram B coincide.

As shown in FIG. 13, the data processing apparatus 100 executes a splitting process to split the first peak AP1 in chromatogram A and generate a peak AP11 and a peak AP12. The vector value of the first peak AP11 in the chromatogram A1 after the splitting process is the same as the vector value of the first peak BP1 in chromatogram B. Note that the data processing apparatus 100 does not add to the Levenshtein distance due to the splitting process.

Next, the data processing apparatus 100 executes a moving process to swap the second peak AP12 and the third peak AP2 in chromatogram A1. The vector value of the second peak AP2 in the chromatogram A2 after the moving process is the same as the vector value of the second peak BP2 in chromatogram B. Note that the data processing apparatus 100 does not add to the Levenshtein distance due to the moving process.

Next, the data processing apparatus 100 executes a substitution process to change the vector value of the third peak AP12 in chromatogram A2. Specifically, the data processing apparatus 100 subtracts a predetermined value from the vector value of the third peak AP12 in chromatogram A2. The vector value of the third peak AP13 in the chromatogram A3 after the substitution process is the same as the vector value of the third peak BP3 in chromatogram B. Note that the data processing apparatus 100 adds the predetermined value subtracted from the vector value of the peak AP12 by the substitution process as the Levenshtein distance. That is, the data processing apparatus 100 calculates the norm of the difference vector value between the vector value of the third peak AP12 in chromatogram A2 and the vector value of the third peak BP3 in chromatogram B, and calculates the calculated norm as the Levenshtein distance.

Next, the data processing apparatus 100 executes a deletion process to delete the fourth peak AP3 in chromatogram A3. In the chromatogram A4 after the deletion process, the fourth peak AP3 does not exist, just like in chromatogram B. Note that the data processing apparatus 100 calculates the norm of the vector value of the peak AP3 deleted from chromatogram A3 as the Levenshtein distance.

Note that the steps that can be taken when transforming from chromatogram A to chromatogram B are not limited to the steps shown in FIG. 12, and other steps are conceivable. The data processing apparatus 100 selects a data process that results in the minimum Levenshtein distance, in order from the first peak in chromatogram A, and calculates the minimum Levenshtein distance by executing the selected data process. In the case of the example shown in FIG. 12, the minimum Levenshtein distance is a value obtained by adding the Levenshtein distance generated by the substitution process (the norm of the difference vector value between the vector value of peak AP12 and the vector value of peak AP13) and the Levenshtein distance generated by the deletion process (the norm of the vector value of peak AP3).

In this way, the data processing apparatus 100 can calculate the minimum Levenshtein distance when making chromatogram A and chromatogram B coincide, by bringing chromatogram A closer to chromatogram B by executing various data processes such as a splitting process, a moving process, a substitution process, and a deletion process on chromatogram A. The data processing apparatus 100 can calculate the minimum Levenshtein distance for all combinations in a plurality of chromatograms.

### Flow of Data Processing of Data Processing Apparatus 100

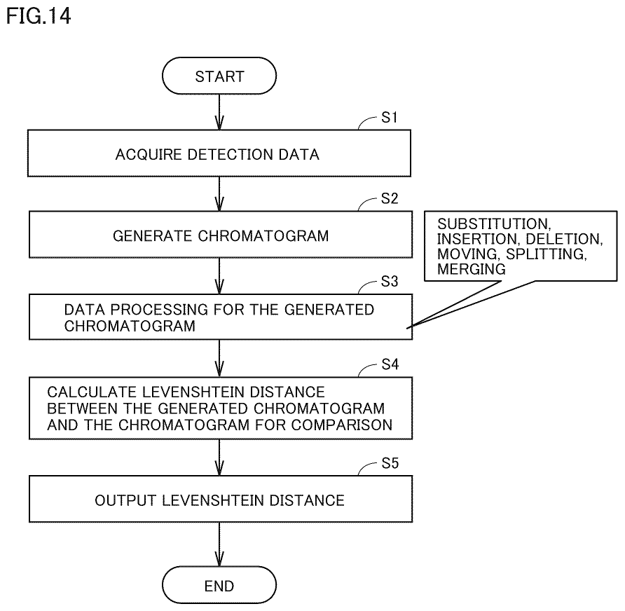

The flow of the data process executed by the data processing apparatus 100 will be described while referencing FIG. 14. FIG. 14 is a flowchart of the data process executed by the data processing apparatus 100 according to the embodiment. The processing steps shown in FIG. 14 (hereinafter, abbreviated as “S”) are realized by the processing unit 101 executing the data processing program 130.

As shown in FIG. 14, the data processing apparatus 100 acquires detection data indicating a signal intensity corresponding to a component in a sample detected by the chromatograph 10 (S1). The data processing apparatus 100 generates a chromatogram indicating a time variation of the signal intensity based on the detection data acquired from the chromatograph 10 (S2).

The data processing apparatus 100 approximates the chromatogram generated in the process of S2 to a chromatogram for comparison by executing at least one data process for calculating the minimum Levenshtein distance, among a plurality of types of data processes such as a substitution process, an insertion process, a deletion process, a moving process, a splitting process, and a merging process, on the chromatogram generated in the process of S2 (S3).

The data processing apparatus 100 calculates the minimum Levenshtein distance between the chromatogram generated in the process of S2 and the chromatogram for comparison (S4). The data processing apparatus 100 outputs the calculated minimum Levenshtein distance (S5). For example, the data processing apparatus 100 displays an image indicating the minimum Levenshtein distance on the display unit 110, stores data indicating the minimum Levenshtein distance in the storage device 103, or transmits data indicating the minimum Levenshtein distance to a cloud server (not shown). After that, the data processing apparatus 100 ends this process.

As described above, the data processing apparatus 100 can calculate the minimum Levenshtein distance with respect to a chromatogram for comparison by executing a data process on a chromatogram generated based on detection data acquired from the chromatograph 10. Furthermore, even if a plurality of peaks overlap in the generated chromatogram or the chromatogram for comparison, the data processing apparatus 100 can approximate the generated chromatogram and the chromatogram for comparison by executing a splitting process or a merging process. Thereby, the data processing apparatus 100 can clearly identify the peaks in the generated chromatogram or the chromatogram for comparison, and can appropriately correspond the peaks between the generated chromatogram and the chromatogram for comparison.

Note that the data processing apparatus 100 is not limited to calculating the minimum Levenshtein distance, but may also extract a combination of chromatograms with the highest degree of similarity from among a plurality of chromatograms, based on the calculated Levenshtein distance.

### Aspects

It is understood by those skilled in the art that the plurality of exemplary embodiments described above are specific examples of the following aspects.

(Aspect 1) A data processing apparatus according to one aspect comprises a data acquisition unit that acquires detection data indicating a signal intensity corresponding to a component in a sample detected by a chromatograph, and a processing unit that processes the detection data acquired by the data acquisition unit. The processing unit generates a chromatogram indicating a time variation of the signal intensity based on the detection data, executes a data process including at least one of a splitting process of splitting one peak to generate a plurality of split peaks and a merging process of merging a plurality of peaks to generate one single peak in the chromatogram, and calculates a Levenshtein distance between the chromatogram and a chromatogram for comparison, based on a result of the data process.

According to the data processing apparatus described in Aspect 1, even if a plurality of peaks overlap in the generated chromatogram or the chromatogram for comparison, by executing a splitting process or a merging process, the generated chromatogram and the chromatogram for comparison can be approximated, and therefore the peaks can be appropriately corresponded between the generated chromatogram and the chromatogram for comparison.

(Aspect 2) In the data processing apparatus described in Aspect 1, the processing unit calculates the Levenshtein distance by matching at least one peak in the chromatogram to at least one peak in the chromatogram for comparison.

According to the data processing apparatus described in Aspect 2, by matching the peaks with each other in the generated chromatogram and the chromatogram for comparison, the generated chromatogram and the chromatogram for comparison can be approximated.

(Aspect 3) In the data processing apparatus described in Aspect 1 or Aspect 2, the processing unit, by executing the splitting process on the chromatogram, generates, as the plurality of split peaks, a first peak corresponding to a comparison target peak in the chromatogram for comparison, and a second peak different from the first peak.

According to the data processing apparatus described in Aspect 3, a peak in the generated chromatogram can be split into a first peak corresponding to a comparison target peak in the chromatogram for comparison, and a second peak different from the first peak.

(Aspect 4) In the data processing apparatus described in any one of Aspect 1 to Aspect 3, the processing unit executes the splitting process when one peak in the chromatogram is larger than a comparison target peak in the chromatogram for comparison.

According to the data processing apparatus described in Aspect 4, when one peak in the chromatogram is less than or equal to a comparison target peak in the chromatogram for comparison, executing a useless splitting process can be avoided.

(Aspect 5) In the data processing apparatus described in any one of Aspect 1 to Aspect 4, the processing unit, by executing the merging process on the chromatogram, generates a single peak corresponding to a comparison target peak in the chromatogram for comparison.

According to the data processing apparatus described in Aspect 5, one peak corresponding to a comparison target peak in the chromatogram for comparison can be generated using a plurality of peaks in the generated chromatogram.

(Aspect 6) In the data processing apparatus described in any one of Aspect 1 to Aspect 5, the data process includes a substitution process of substituting a value of at least one peak in the chromatogram with another value, an insertion process of inserting at least one peak in the chromatogram, a deletion process of deleting at least one peak in the chromatogram, and a moving process of moving at least one peak in the chromatogram to another time.

According to the data processing apparatus described in Aspect 6, by executing various data processes such as a substitution process, an insertion process, a deletion process, a moving process, a splitting process, and a merging process, the generated chromatogram and the chromatogram for comparison can be approximated.

(Aspect 7) In the data processing apparatus described in any one of Aspect 1 to Aspect 6, the chromatograph detects an ion intensity of a component as a signal intensity for each mass-to-charge ratio. The chromatogram indicates a time variation of the ion intensity detected for each mass-to-charge ratio by the chromatograph.

According to the data processing apparatus described in Aspect 7, a data process can be executed on a chromatogram indicating a time variation of the ion intensity of a component in a sample detected for each mass-to-charge ratio.

(Aspect 8) In the data processing apparatus described in any one of Aspect 1 to Aspect 6, the chromatograph detects an absorbance of a component as a signal intensity for each wavelength. The chromatogram indicates a time variation of the absorbance detected for each wavelength by the chromatograph.

According to the data processing apparatus described in Aspect 8, a data process can be executed on a chromatogram indicating a time variation of the absorbance of a component in a sample detected for each wavelength.

(Aspect 9) A data processing method according to one aspect includes a step of acquiring detection data indicating a signal intensity corresponding to a component in a sample detected by a chromatograph, and a step of processing the detection data acquired by the acquiring step. The step of processing the detection data includes a step of generating a chromatogram indicating a time variation of the signal intensity based on the detection data, a step of executing a data process including at least one of a splitting process of splitting one peak to generate a plurality of split peaks and a merging process of merging a plurality of peaks to generate one single peak in the chromatogram, and a step of calculating a Levenshtein distance between the chromatogram and a chromatogram for comparison, based on a result of the data process.

According to the data processing method described in Aspect 9, even if a plurality of peaks overlap in the generated chromatogram or the chromatogram for comparison, the computer (processing unit), by executing a splitting process or a merging process, can approximate the generated chromatogram and the chromatogram for comparison, and therefore can appropriately correspond the peaks between the generated chromatogram and the chromatogram for comparison.

(Aspect 10) A data processing program according to one aspect causes a computer to execute a step of acquiring detection data indicating a signal intensity corresponding to a component in a sample detected by a chromatograph, and a step of processing the detection data acquired by the acquiring step. The step of processing the detection data includes a step of generating a chromatogram indicating a time variation of the signal intensity based on the detection data, a step of executing a data process including at least one of a splitting process of splitting one peak to generate a plurality of split peaks and a merging process of merging a plurality of peaks to generate one single peak in the chromatogram, and a step of calculating a Levenshtein distance between the chromatogram and a chromatogram for comparison, based on a result of the data process.

According to the data processing program described in Aspect 10, even if a plurality of peaks overlap in the generated chromatogram or the chromatogram for comparison, the computer (processing unit), by executing a splitting process or a merging process, can approximate the generated chromatogram and the chromatogram for comparison, and therefore can appropriately correspond the peaks between the generated chromatogram and the chromatogram for comparison.

(Aspect 11) A data processing system according to one aspect comprises a chromatograph and a data processing apparatus that processes data. The data processing apparatus comprises a data acquisition unit that acquires detection data indicating a signal intensity corresponding to a component in a sample detected by the chromatograph, and a processing unit that processes the detection data acquired by the data acquisition unit. The processing unit generates a chromatogram indicating a time variation of the signal intensity based on the detection data, executes a data process including at least one of a splitting process of splitting one peak to generate a plurality of split peaks and a merging process of merging a plurality of peaks to generate one single peak in the chromatogram, and calculates a Levenshtein distance between the chromatogram and a chromatogram for comparison, based on a result of the data process.

According to the data processing system described in Aspect 11, even if a plurality of peaks overlap in the generated chromatogram or the chromatogram for comparison, by executing a splitting process or a merging process, the generated chromatogram and the chromatogram for comparison can be approximated, and therefore the peaks can be appropriately corresponded between the generated chromatogram and the chromatogram for comparison.

### REFERENCE SIGNS LIST

1 Data processing system, 10 Chromatograph, 11 Container, 12 Liquid sending pump, 13 Injector, 14 Column, 15 Detector, 100 Data processing apparatus, 101 Processing unit, 102 Memory, 103 Storage device, 104 Interface, 110 Display unit, 120 Input unit, 130 Data processing program.

1. A data processing apparatus for processing data, comprising:
a data acquisition unit that acquires detection data indicating a signal intensity corresponding to a component in a sample detected by a chromatograph; and
a processing unit that processes the detection data acquired by the data acquisition unit, wherein
the processing unit:
generates a chromatogram indicating a time variation of the signal intensity based on the detection data,
executes a data process including at least one of a splitting process of splitting one peak to generate a plurality of split peaks and a merging process of merging a plurality of peaks to generate one single peak in the chromatogram, and
calculates a Levenshtein distance between the chromatogram and a chromatogram for comparison, based on a result of the data process.

2. The data processing apparatus according to claim 1, wherein the processing unit calculates the Levenshtein distance by matching at least one peak in the chromatogram to at least one peak in the chromatogram for comparison.

3. The data processing apparatus according to claim 1, wherein the processing unit, by executing the splitting process on the chromatogram, generates, as the plurality of split peaks, a first peak corresponding to a comparison target peak in the chromatogram for comparison, and a second peak different from the first peak.

4. The data processing apparatus according to claim 1, wherein the processing unit executes the splitting process when one peak in the chromatogram is larger than a comparison target peak in the chromatogram for comparison.

5. The data processing apparatus according to claim 1, wherein the processing unit, by executing the merging process on the chromatogram, generates the single peak corresponding to a comparison target peak in the chromatogram for comparison.

6. The data processing apparatus according to claim 1, wherein the data process includes a substitution process of substituting a value of at least one peak in the chromatogram with another value, an insertion process of inserting at least one peak in the chromatogram, a deletion process of deleting at least one peak in the chromatogram, and a moving process of moving at least one peak in the chromatogram to another time.

7. The data processing apparatus according to claim 1, wherein
the chromatograph detects an ion intensity of the component as the signal intensity for each mass-to-charge ratio, and
the chromatogram indicates the time variation of the ion intensity detected for each said mass-to-charge ratio by the chromatograph.

8. The data processing apparatus according to claim 1, wherein
the chromatograph detects an absorbance of the component as the signal intensity for each wavelength, and
the chromatogram indicates the time variation of the absorbance detected for each said wavelength by the chromatograph.

9. A data processing method for a computer to process data, comprising:
a step of acquiring detection data indicating a signal intensity corresponding to a component in a sample detected by a chromatograph; and
a step of processing the detection data acquired by the acquiring step, wherein the step of processing the detection data includes:
a step of generating a chromatogram indicating a time variation of the signal intensity based on the detection data,
a step of executing a data process including at least one of a splitting process of splitting one peak to generate a plurality of split peaks and a merging process of merging a plurality of peaks to generate one single peak in the chromatogram, and
a step of calculating a Levenshtein distance between the chromatogram and a chromatogram for comparison, based on a result of the data process.

10. (canceled)

11. A data processing system for processing data, comprising:
a chromatograph; and
a data processing apparatus that processes data, wherein
the data processing apparatus comprises:
a data acquisition unit that acquires detection data indicating a signal intensity corresponding to a component in a sample detected by the chromatograph; and
a processing unit that processes the detection data acquired by the data acquisition unit, wherein
the processing unit:
generates a chromatogram indicating a time variation of the signal intensity based on the detection data,
executes a data process including at least one of a splitting process of splitting one peak to generate a plurality of split peaks and a merging process of merging a plurality of peaks to generate one single peak in the chromatogram, and
calculates a Levenshtein distance between the chromatogram and a chromatogram for comparison, based on a result of the data process.
